(19) United States
(12) Patent Application Publication
(10) Pub. No.: US 2010/0156289 A1
(43) Pub. Date: Jun. 24, 2010

(54) Halogen Incandescent Lamp Having a Carbide-Containing Luminous Element

(75) Inventors: Axel Bunk, Munchen (DE); Matthias Damm, Gaimersheim (DE); Georg Rosenbauer, Wassertrudingen (DE); Christa Bunk, Munchen (DE); Ludwig Bunk, Munchen (DE); Maximilian Bunk, Munchen (DE); Stefan Bunk, Munchen (DE)

Correspondence Address: OSRAM SYLVANIA INC, 100 ENDICOTT STREET, DANVERS, MA, 01923, US

(73) Assignee: Osram Gesellschaft Mit Beschrankter Haftung, Munchen (DE)

(21) Appl. No.: 12/226,971

(22) PCT Filed: Apr. 26, 2007
(86) PCT No.: PCT/EP2007/054105

§ 371 Date: Nov. 3, 2008

(30) Foreign Application Priority Data
May 3, 2006 (DE) 10 2006 020 581.2

(51) Int. Cl. H01K 1/50; H01J 9/00

(52) U.S. Cl. 313/578; 445/27

(57) ABSTRACT

The invention relates to an incandescent lamp having a carbide-containing luminous element and current supplies holding the luminous element. A luminous element is introduced into a bulb together with a filling in a vacuum-tight manner, the luminous element having a metal carbide the melting point of which is preferably above that of tungsten, and the luminous element being helical. The luminous element has a core wire and a wrapped filament and is constituted of various materials and contains a metal carbide.

### TECHNICAL FIELD

The invention proceeds from a halogen incandescent lamp having a carbide containing luminous element in accordance with the preamble of claim 1. Such lamps are used for general illumination and for photooptical purposes.

### PRIOR ART

In accordance with DE-A 31 23 442, luminous elements having a wrapped filament are used to increase the luminance in the case of tungsten lamps. Wrapping wire and wrapped filament are made from tungsten. In this case, a thicker tungsten wire, which chiefly determines the power consumption and is denoted below as “core wire”, is wrapped by a thinner tungsten wire. A goal of the wrapped filament is the enlargement of the luminous element surface, and thus the emitting surface. The result of this measure is to improve the ratio, otherwise chiefly defined via the wire diameter, between the wire cross sectional surface that is relevant to the power consumption, and the wire surface that is relevant to the emission. The effectively emitting surface is, however, determined by the filament geometry. In simplified terms, by enlarging the emitting surface a defined power is emitted along a shorter piece of the luminous wire. It is assumed in this case that the other influences featuring in the energy balance remain substantially constant.

U.S. Pat. No. 3,237,284 and U.S. Pat. No. 3,219,493 disclose luminous elements in the case of which both were core wire and the wrapped filament consist of TaC, or contain the latter at least as main chemical component. In a very similar way to that of the tungsten filament, the goal of the wrapped filament in these patents is to increase the radiant emission that is attained by the geometric enlargement surface. Both the wrapping wire and the core wire consist chiefly of tantalum carbide, and there are no proposals for any different material pairings of core wire and wrapping wire. Moreover, there is provided a relatively large turn spacing w of the wrapping wire with diameter d that lies between w>0 and w<2d. The core wire is not completely covered, as may also clearly be seen in the associated figures. A description is given of a single ply wrapped filament, it being possible in addition for connecting purposes to apply to the core wire a carbon layer that is then used in the heating for the purpose of carburization and local fusing of core wire and wrapping wire, and is therefore no longer present in the finished lamp.

### SUMMARY OF THE INVENTION

The object of the present invention is to increase the service life of a generic lamp.

This object is achieved by characterizing features of claim 1. Particularly advantageous refinements are to be found in the dependent claims.

Tantalum carbide has a melting point higher than that of tungsten by approximately 500 K. The temperature of a luminous element made from tantalum carbide can therefore be set substantially higher than that of a luminous element made from tungsten. Because of the higher temperature of the luminous element, and the increased emission of the tantalum carbide in the visible spectral region, it is possible to implement substantially higher light yields in the case of lamps with tantalum carbide as luminous elements than in the case of lamps with conventional incandescent elements made from tungsten. So far, marketing of tantalum carbide lamps has been obstructed chiefly by the brittleness of the tantalum carbide, as well as by the rapid decarburization or destruction of the luminous element at high temperature.

In order to keep the outlay on production engineering in the construction of a TaC lamp as low as possible, a TaC lamp should be constructed in the same geometry as a conventional low voltage halogen lamp with a bulb using silica glass or hard glass technology. Bulbs made from aluminum oxide ceramic are also possible in a way similar to the case of the metal halide lamps with ceramic discharge vessels that are available on the market.

According to the invention, use is made of a luminous element that is designed as a wrapped filament consisting of a core wire and wrapping. As wrapping, use is mostly made of a wrapping wire or a combination of coating and wrapping wire. The wrapping can also comprise a number of wrapping wires.

In particular, the first step is to fabricate a wrapping wire, consisting of carburizable material such as tantalum wire, for example, together with a core wire made from another high melting material. In a first embodiment, this other material is carburizable under the selected conditions, in particular, for Hf, Zr, Nb, V, Ti, W or their alloys. These filaments are then used to construct rod lamps. Subsequently, this luminous element is carburized in the open rod lamp by using a mixture of methane and hydrogen. Depending on the free reaction enthalpy for carbide formation, and on carbon solubility, the metals are mostly converted into the respective metal carbides. In the case of a second embodiment, the other material is metals such as for example, rhenium, osmium, iridium, ruthenium, or else tungsten, that do not form carbides under the suitably selected conditions at a low temperature of the luminous element. These materials remain in the pure metal form. With regard to the basic properties of carburization, reference may be made by way of example to S. Okoli, R. Haubner, B. Lux, Surface and Coatings Technology 47 (1991), 585-599, and G. Hörz, Metall 27, (1973), 680. The carburized rod lamps are subsequently pumped out, filled with fill gas and, lastly, the exhaust tube is sealed off and the lamp is thereby sealed.

In particular cases, instead of carburizing the filament in the open rod lamp it is also possible for the carburization to be performed in the sealed off, closed lamp. Fill gas of the lamp then must correspondingly be provided with a carbon excess and be adapted, but this is substantially more difficult and is mostly achieved in practice only for filament carburization temperatures <3200 K. A limiting factor is the melting point of the pure metals. For example, tantalum has a melting point of 2996° C.

The high fracture strength of the as yet uncarburized filaments is advantageous in the case of filament carburization in the finished lamp. Transporting lamps to the customer is thus more effectively secured. When the luminous element is first switched on at the actual burning site, the carburization of the filament then begins, together with the accompanying reduction in strength owing to embrittlement.

On the basis of the different carburization times (during the lamp fabrication or not until at the customer's), the embodiments described here are valid both for the pure luminous element metals and metal alloys, and for the carburized metals and metal alloys. The pure metals or metal alloys are, however, converted into the respective metal carbides or metal carbide alloys when the lamp is switched on, at the latest.

Despite the fact that the melting point of TaC is higher by 500 K by comparison with tungsten, the evaporation rate of carbon at a reference temperature of approximately 3400 K is a multiple higher than that of the tungsten luminous element. The high evaporation rates of carbon over the TaC luminous element can certainly be lowered by various measures. However, this takes place chiefly by raising the cold filling pressure of the lamp, by applying carbon cycle processes, by introducing a continuous flow from a carbon source into a carbon sink, or by lowering the vapor pressure of the TaC luminous element at a constant color temperature. A preferred measure here is to form the alloys HfC—TaC, ZrC—TaC, etc. or to form substoichiometric TaC. The design of a completely regenerative cyclic process, or the complete stabilization of the luminous element in a carbon containing atmosphere is, however, difficult.

The essential principle parameter acting on the carbon vapor pressure and thus—to the extent that there is no completely regenerative carbon cycle process or a complete stabilization of the luminous element in a C-containing atmosphere—the service life of the tantalum carbide lamp is the luminous element temperature. The luminous element temperature is certainly not identical to the color temperature of the lamp, but it is closely connected thereto, compare, for example, Becker/Ewest: “Die physikalischen und strahlungstechnischen Eigenschaften des Tantalcarbids” [“The physical and radiation properties of tantalum carbide”], Zeitschrift für technische Physik, No. 6, pages 216 f. (1930). In the region of typical luminous element temperatures, the difference is mostly less than 100 K. However, if the color temperature of the luminous element is lowered, there is a rapid decrease in the light emission in the visible region in accordance with the Planck radiation law. It is thereby plausible to attain a substantial lengthening of service life, because the carbon vapor pressure over TaC or other metal carbides drops sharply with falling temperature.

A first stipulation of the object consists in finding solutions to achieving satisfactory luminances even in the case of relatively low luminous element temperature. Help with this is provided by the higher emission of TaC by comparison with tungsten, at least at temperatures of approximately 3000 to 3300 K. An important goal in the use of tantalum carbide lamps is therefore the use of the higher emissivity in the visible spectral region at the color temperatures that are “lower” by approximately 3000 K by comparison with the melting point of TaC, that is to say, color temperatures from 2500 to 3350 K, for example. Metal carbide lamps need not necessarily be operated at a relatively high temperature in order to achieve higher light yields compared with tungsten halogen incandescent lamps.

Furthermore, the aim is to examine briefly the failure mechanism of lamps having luminous elements made from a metal carbide in the absence of a completely regenerative cyclic process and/or a stabilization of the luminous element in a suitable gas atmosphere. The failure mechanism closely follows, at least in principle, the hot spot model as described for lamps with a tungsten filament, see H. Hörster, E. Kauer, W. Lechner, “Zur Lebensdauer von Glühlampen” [“On the service life of incandescent lamps”], Philips techn. Rdsch. 32, 165-175 (1971/72). A small “disturbance” along the luminous element wire, for example an increased power input at a grain boundary, a small local change in the material data, a locally restricted reduction in the wire diameter, a local contamination in the luminous wire, an excessively small spacing between two turns of a filament, etc., give rise to a slight locally restricted heating of a location compared with their surroundings. The local restriction is limited in this case to at most two turns. The local increase in the temperature has the effect that material is evaporated more strongly from this location, and the latter is therefore preferably tapered in relation to the surroundings, resistance at this location thereby rising. Since the increase in the resistance is limited to a small area, the total resistance of the luminous element therefore changes only slightly, or it is increased only by a greatly smaller fraction than the resistance at the considered location. An increased power input occurs at the narrowly limited location with a slightly increased resistance, because the same current, or only a comparatively slightly lowered current, flows through this location, which now has an increased resistance. Consequently, the temperature is increased further, and this in turn accelerates the tapering of this location relative to the surroundings, etc. The formation of a thin location occurs automatically in the accelerated way described, and finally leads to the burning through of the luminous element at this location. In the case of lamps made from metal carbides such as tantalum carbide, there is added as a further effect by comparison with incandescent elements made from tungsten that the subcarbide Ta₂C produced during the carbon evaporation has a specific electrical resistance that is higher than TaC by a factor of more than 3, compare, for example s. Okoli, R. Haubner, B. Lux, “Carburization of tungsten and tantalum filaments during low pressure diamond deposition”, Surface and Coatings Technology, 47 (1991), 585-599. The effect of this influence is that the destructive mechanism in the case of luminous elements made from tantalum carbide builds up yet more quickly than those made from tungsten. Consequently, an effective mechanism for suppressing the problem is even more urgently required than in the case of the use of tungsten.

An additional second object therefore consists in avoiding or at least lessening the described destructive mechanism, or in implementing general measures to lengthen the service life.

An additional third object consists in stabilizing the brittle and therefore prone to fracture metal carbide.

Moreover, one advantageous feature of the invention consists in designing filaments made from at least one metal carbide as wrapping wire or as core wire, and combining them with another second material as wrapping wire or as core wire. The use of various materials for core wire and wrapping wire opens up decisive advantages for lamps with metal carbide filament by comparison with U.S. Pat. No. 3,237,284 and U.S. Pat. No. 3,219,493. This design of the filament can be used to contribute to the achievement of the object described in the way described as follows.

In the case of the wrapped filament, the light exit surface of a metal carbide incandescent filament is increased by enlarging the emitting luminous element surface. In a way similar to the case of the tungsten wrapped filament, it is firstly possible to increase the luminance or to achieve the same luminance at a lower luminance element temperature. Achieving high luminances is of particular interest for the use of the lamps in reflectors or optical projection systems. The wrapping wires preferably have a typical diameter in the range of 7 μm-150 μm. The core wires have a typical diameter in the range of 80 μm to 800 μm. A particular example of the projection lamp with 24 V and 250 W has, for example, a wrapping wire diameter of 20 μm and a core wire diameter of 255 μm, alongside 11 turns of the core wire and 3200 turns of the wrapping wire. Typical power ranges are 10 watts to 1000 watts.

In this case, typical ratios of the diameters of wrapping wire and core wire are from 1/3 to 1/20. The ratio of wrapping wire (for example tantalum wire diameter 25 μm) to wrapped core wire (for example rhenium wire diameter 190 μm) is preferably to be approximately 1/5 to 1/15.

In the case of a pure tungsten/tungsten solution, the turn spacing of the tungsten wrapping wire is typically always greater than the diameter of the wrapping wire, that is to say the pitch factor of the wrapping is always greater in practice than 1.2. Given a power of 250 W, the pitch factor of the tungsten wrapping wire is, for example, typically 1.8, and the pitch factor of the tungsten core wire turn is typically 1.3. The spacing between the outsides of two neighboring turns of the wrapped filament is always >0, but smaller than twice the core wire diameter.

The diameter of the core wire, and the pitch factors and number of turns in the case of the metal carbide wrapped filament made from various materials are similar as in the case of tungsten (diameter 80 μm-800 μm and pitch 1.1-2.0, number of turns 3-30. In general, the pitch ratios of the metal carbide wrapped filament made from various materials are somewhat greater (1.1-3.0) since, owing to the increase in volume of the metal during carburization, the turn spacings vary somewhat and become somewhat tilted.

The larger pitch is intended to avoid an interturn fault.

The pitch factors of the wrapping wire in the case of the metal carbide wrapped filament made from various materials (1.0-1.4) tend to be smaller than in the case of tungsten, since the aim is, after all, to produce a covering that is as closed as possible. Since the increase in volume of the metal during carburization must be taken into account, the pitch factor is certainly always substantially greater than 1.0 before the carburization. However, in the case of the present invention this pitch factor is preferably clearly less than 1.4, in particular preferably lying between 1.0 and 1.2, in the burned-in state. In addition, it is also necessary when designing the filament to take account of the luminous element “springing open”, since the spinning wire presses the individual turns apart from one another because of its length extension during the carburization.

The particular design of the wrapped filament also contributes to weakening the destructive mechanism described in the case of hot spot formation, compare the second additional object. The external wrapping wire is firstly decarburized in the case of an at least not completely regeneratively running cyclic process. Since—by contrast with a simple luminous element consisting of only one wire—said wrapping wire contributes only slightly to the power consumption at least initially only relatively little more power is fed into a hotter location that is beginning to form; that is to say the temperature rise at such a location runs relatively slowly.

This effect can certainly be initiated in principle even given the use of the same materials for core wire and wrapping wire. For example, core wire and wrapping wire can consist of tantalum carbide. It is then essential for the wrapping wire to cover the core wire as completely as possible, that is to say at least 90% of the surface of the core wire, preferably at least 95% of the surface of the core wire, that is to say the pitch factor of the wrapped filament is close to 1, or only slightly greater than 1. Consequently, the evaporation takes place substantially only from the “external” surface of the wrapping wire. However, only very little material evaporates from the core wire. When use is made of various materials for core wire and wrapping wire/wrapping wires, there are, however, further advantages on offer, in particular in the case of the following embodiments:
(i) Core wire made from a moderately priced material of high vapor pressure, wrapping wire made from an expensive material of low vapor pressure. This leads to improvement of quality in conjunction with a relatively low rise in costs.
(ii) Use of metal carbide as core wire; coating of this core wire with carbon, or wrapping this core wire with carbon fibers, wrapping the carbon coating or the carbon fibers thereupon with a wrapping made from another metal carbide. Here, the “middle” layer made from carbon acts as a source in the sense of DE 10 2004 052 044.5 and replaces the carbon evaporated to the outside from the wrapped filament, which leads to an increase in the service life. Connection of the wrapping wire with the core wire as described in U.S. Pat. No. 3,237,283 is not concerned here.
(iii) Use of a core wire that does not form carbides and scarcely dissolves carbon, in particular by using the materials from the group Re, Os, Ir, and of a metal carbide/a metal carbide alloy as wrapping wire. This leads to an increase in impact strength.
(iv) Use of a core wire made from an inexpensive material that does not form carbides, in particular W, Ta, Zr; coating this core wire with a material acting as a carbon diffusion barrier, or wrapping this core wire with a wire made from a material that does not form carbides, in particular Ir, Os, Re; then, wrapping this second “middle” layer with a third ply, in particular a wire made from metal carbide. This leads to an increase in impact strength in conjunction with the use of a core wire made from a relatively inexpensive material.
(v) Use of a material that does not form carbides or dissolve carbon, such as Ir, Os, Re as core wire; coating this core wire with carbon or wrapping this core wire with carbon fibers, wrapping this carbon coating or carbon fibers thereon with a wrapping made from metal carbide. Here, the “middle” layer made from carbon acts as a source in the sense of DE 10 2004 052 044.5 and replaces the carbon evaporated to the outside from the wrapped filament, which leads to an increase in the service life. In this case, a high impact strength is attained by using a core wire made from metal. Instead of a core wire that does not form carbides, it is also possible to use a core wire made from a material that forms carbides and which is coated with the elements Re, Os, Ir as possible carbon diffusion barrier.

Particular exemplary embodiments are presented furtherbelow for these various options.

The geometric design of the wrapped filament is advantageously done such that the turn spacing of the wrapping wire is in the range of the diameter of the wrapping wire, that is to say there is a pitch factor of 1.0 to 1.4, preferably of 1.01 to 1.2. As a result, the turns of the wrapping wire virtually touch one another. Evaporation of the core wire which, after all, can consist of metal carbide or metal, can be most efficiently prevented or curbed by covering in as closed a fashion as possible when wrapping. It is to be considered in this case that there is an increase in volume during carburization. During wrapping, a very slight turn spacing of approximately 5-10% of the diameter of the wrapping wire can preferably be observed. After the carburization, this gap between the turns of the wrapping wire is practically virtually completely closed by the increase in volume, and so the turn becomes smaller than 5% of the diameter, in particular 0.5 to 4.5%.

When producing the wrapped filaments, it is possible in principle to proceed such that these are firstly wound from core wire and wrapping wire, and subsequently carburized on in the rod lamp in an atmosphere containing hydrocarbon. Alternatively, the carburization can also not be performed until later when burning in the lamp at the customer's, the carbon then being brought to the fill gas either from carbon containing additives, and/or by transporting carbon from solid carbon fibers or carbon layers.

Since the carburization results in an increase in wire volume, this can lead to stresses. In order to weaken the build up of excessively large strains during carburization, it is possible to proceed when carburizing in such a way that the core wire is firstly coated with carbon, for example by means of CVD or PVD coating, flashing, etc., or is further provided with a carbon containing drawing lubricant from the wire drawing, or is wrapped with a first ply of a thin carbon wrapping fiber (typically 5 to 12 μm, for example 7 μm). Not until then is the wrapping wire wound around the core wire. The carbon from the coating or from the fiber or from the residue of drawing lubricant or from the first ply of the wrapping is used when heating for the purpose of carburization, that is to say the carbon layer or the carbon fiber becomes thinner, and this leads to a reduction in layer thickness and contributes to the fact that the enlargement in volume occurring during carburization can be largely compensated. In addition, carbon can further be fed via a hydrocarbon containing atmosphere. Depending on the design of the carburization process, a specific portion of the carbon required to carburize the tantalum is removed from the gas phase, a further portion is removed from the carbon layer. The carburization process can preferably be designed such that, or the carbon layer or the carbon fiber can be selected to be so thick that carbon is still present even after the carburization.

When the external wrapping wire is decarburized during operation of the lamp in the case of an at least not completely regeneratively running cyclic process, carbon is permanently resupplied from the carbon layer surrounded by the wrapping wire, that is to say the carbon layer or carbon fiber acts as a source in the sense of DE-A 10 2004 052 044. As described therein, it is necessary in this case to fix a sink in the gas space of the lamp in order to avoid an enrichment of the gas atmosphere with carbon.

U.S. Pat. No. 3,237,284 and U.S. Pat. No. 3,219,493 address only the geometric effect of the increase in the light exit surface that occurs when in the case of a filament, the wrapping wire and wrapped core wire consisting substantially of the same material, tantalum in this case and, after carburization, tantalum carbide.

If, however, a pitch factor of close to 1 is selected, that is to say if the individual turns of the wrapped filament virtually completely cover the core wire (preferably more than 95% of the surface), the evaporation preferably takes place from the external surface of the wrapped filament, and this leads to an increase in service life, thus to an improvement surpassing the benefit described in U.S. Pat. No. 3,237,284 and U.S. Pat. No. 3,219,493. If, furthermore, various materials are combined in the luminous element, yet further advantages are additionally added to the already known geometric enlargement of the light exit surface, as well as the limitation of the carbon evaporation onto the spinning wire, see points (i)-(v) as discussed above.

For example, the wrapping wire is made from tantalum, and the wrapped core wire is made from other high melting materials such as, for example, tungsten, rhenium, hafnium, zirconium, niobium, osmium, vanadium, titanium, ruthenium, carbon, or alloys of these materials. One advantage here is the following: tungsten is the metal with the highest melting point (3380° C.), it reacts with carbon to form tungsten carbide, which has a substantially lower melting point of 2630° C. By contrast, a metal such as rhenium does not react with carbon, but has a somewhat lower melting point, at 3180° C, than tungsten. Hafnium reacts with carbon, and HfC even has a yet higher melting point, by approximately 100 K than TaC, etc.

For example, the minimization of the turn spacing of the wrapping wire made from the material HfC (pitch factor close to 1) is important in the system of core wire made from TaC/wrapping wire made from HfC. Covering preferably at least 95% of the core wire in as closed a fashion as possible with the wrapping wire attains a uniform alloying of the TaC to TaC/HfC 80/20. The evaporation of material from the core wire can thereby be largely repressed, or the evaporation takes place virtually exclusively from the external surface of the wrapping wire.

The wrapping can also be carried out in a multi-ply fashion. Further additional material pairings in the case of core wire and wrapping wire are therefore possible such as, for example, a single ply or multi-ply wrapping made from Ta wire and, if appropriate, also carbon fiber or a carbon coating a rhenium core wire. A Re core wire is preferably firstly wrapped with a carbon fiber/carbon layer and then with a tantalum wire. The rhenium wire scarcely absorbs carbon, and the carbon evaporated from the external TaC wire is replaced in the sense of DE-A 10 2004 052 044 by carbon transported from inside by diffusion from the carbon fiber or the carbon layer. Again, the intensified evaporation of carbon can be repressed by using a multi-ply wrapping made from Ta, Hf, Zr, V, Ti, W carbide, optionally with additional carbon wrapping/carbon layer. In the case of the two-ply or multi-ply wrapping, there is likewise a desire for the turn spacing of the wrapping wires to be as small as possible, preferably corresponding to a covering of at least 95% of the surface, in order to obtain a cover formed as uniformly as possible.

The achievement of the additional second and third objects can be optimized by the use of a number of materials, and this is to be described below with the aid of a few examples.

First embodiment: rhenium does not react with carbon, but has, at 3180° C., a relatively high melting point close to tungsten (3380° C.). If, in a simplest case, a rhenium core wire is wrapped with a wrapping wire made from a tantalum alloy, after the carburization a rhenium wire is obtained that has a tantalum carbide wrapping which is virtually closed, preferably by up to at least 95% of the surface. Since rhenium does not react with carbon, the Re core wire also does not change its chemical composition in the event of carburization. The initial Ta wrapping is transformed into a TaC wrapping. It is advantageous in the case of this material combination that although the desirable radiation properties of the tantalum carbide at the large surface of the wrapping can be used for lighting purposes, the rhenium behaving indifferently to the carbon is substantially responsible on its own for the current transport. If the external tantalum wrapping wire is decarburized in lamp operation given an at least not completely regeneratively running cyclic process, the electrical resistance of the substantially thicker rhenium core wire changes only insubstantially. Since the decarburization essentially affects only the external wrapping ply, the service life of this filament made from the material combination of Re—TaC is lengthened by a factor of at least 2.

Second embodiment: hafnium carbide has a yet higher melting point than tantalum carbide. However, hafnium is substantially more difficult to procure and much more expensive than tantalum. Consequently, it may be recommended to design a wrapped filament such that the core wire consists of TaC, and the wrapping wire of HfC. It is thereby possible for the material use of Hf to be substantially reduced. Because of the higher melting point of HfC, a positive effect on the service life is obtained. If a diffusive mixing of the Ta from the TaC and of the Hf from the HfC occurs in lamp operation, the content of tantalum rises in the external region of the luminous element. This leads to a further rise in the melting point, and therefore has an additional positive effect on the service life. The melting point maximum occurs for a composition of approximately 80% TaC+20% HfC (Agte, Altherthum, Z. Physik, No. 6 (1930)). A melting point maximum also occurs at approximately 80% TaC+20% ZrC. Consequently, it is also particularly preferred to use an alloy of TaC/HfC or TaC/ZrC with a proportion of 15 to 25% by weight HfC and ZrC for example, in the case of the use of a simple luminous element without wrapping.

The TaC—HfC wrapped filament is fabricated by wrapping the core wire made from Ta (or from a Ta alloy) with a wrapping wire made from Hf (or from a Hf alloy). The wrapped wire, which has the material combination of Ta/Hf (or Ta alloy/Hf alloy) is wound to form a filament and, finally, carburized in a rod lamp or the finished lamp.

Third embodiment: for special applications, even a wrapping of a tungsten core wire with a wire made from metal carbide is advantageous. This happens despite a possible carburization of the tungsten that leads to the lowering, mentioned at the beginning, of the melting point of 2630° C. for tungsten carbide. Here, the different formation enthalpy of tantalum carbide and tungsten carbide is utilized in the case of a single ply wrapping. The carburization can be controlled in such a way that the carburization of the tungsten is minimized because of the higher affinity of the tantalum with carbon. It is thereby possible to produce a wrapped filament made from metal core wire, for example tungsten, and a wrapped filament made from metal carbide, for example tantalum carbide, by specific selection of parameters during carburization (temperature, time, throughflow, pressure, concentration of the carbon, etc.). At least in the case of operation of this luminous element below approximately 3000 K, a carburization of the tungsten, that is to say a transfer of the carbon from the tantalum carbide (or another metal carbide) to the tungsten, plays only a subordinate role. In this case, as well, the use of tantalum carbide is still advantageous because of its selective radiator properties. Under the selected conditions of a sufficiently low luminous element temperature, tungsten is therefore regarded as a metal that does not form carbide.

The embodiment described below is frequently preferred in order to operate a luminous element with a tungsten core wire at relatively high temperatures. The tungsten core wire is firstly wrapped with a rhenium wire, and then with another metal wire so as to produce a two-ply wrapping. The first ply of rhenium wrapping wire acts as a carbon diffusion barrier. Alternatively, it is also possible to select Os, Ir or Ru as material for the diffusion barrier. The second ply of wrapping wire consists of a carburizable metal. This is transformed into a metal carbide during the carburization. Tantalum or tantalum alloys are preferably to be used here as metal. Alternatively, other metals or alloys from the same metals such as, for example, Hf, Nb, V, Zr, Ti, W, are suitable.

Alternatively, it is possible in a manner similar to U.S. Pat. No. 1,854,970 firstly to coat the tungsten wire with rhenium, and only then to wrap this coated wire with a metal wire that delivers a metal carbide during carburization.

In a further embodiment, the mechanical stabilization of a brittle core wire, mostly a metal carbide such as TaC, can be performed by a less brittle wrapping wire—the material here being C, Re, Os, Ir or a less brittle material such as Zr, Hf, Nb, V, Ti, W carbide/metal carbide alloy, metal nitride, metal boride. The converse case of a mechanical stabilization of the wrapping wire, which is brittle after the carburization, made from metal carbide such as, in particular, TaC, by an uncarburized wrapped core wire made from metals, particularly, by way of example, rhenium, carbon or less brittle metal carbide alloys employing, for example, Hf, Zr, Nb, Ti, V and W is also possible as an alternative.

The use of a core wire made from Re as carrier material and wrapping wires made from carburizable metals that form metal carbides such as tantalum carbide after the carburization may be emphasized again. Rhenium, osmium or iridium is not carburized and therefore not embrittled. A mechanically stable luminous element is obtained in this way.

The designs described here can also be applied to lamps having luminous elements of other metal carbides (for example hafnium carbide, zirconium carbide, niobium carbide, titanium carbide, vanadium carbide, tungsten carbide) and their alloys with metal nitrides and metal borides.

### BRIEF DESCRIPTION OF THE DRAWINGS

The aim below is to explain the invention in more detail with the aid of a number of exemplary embodiments. In the figures:

FIG. 1 shows an incandescent lamp having a carbide luminous element in accordance with one exemplary embodiment; and

FIG. 2 shows a helically wound luminous body for the incandescent lamp in accordance with FIG. 1.

### PREFERRED DESIGN OF THE INVENTION

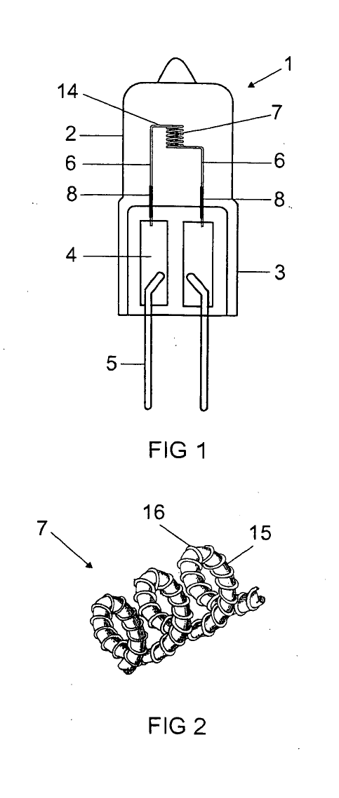

FIG. 1 shows an incandescent lamp 1 that is pinched at one end and has a bulb made from silica glass 2, a pinch 3, and internal supply leads 6 that connect foils 4 in the pinch 3 to a luminous element 7. The luminous element is a singly wound, axially arranged wire made from TaC and whose non-helically wound ends 14 are guided further transverse to the lamp axis. The external leads 5 are attached to the foils 4 on the outside. The inside diameter of the bulb is 9 mm. The filament ends 14 are subsequently bent away parallel to the lamp axis and form the internal supply leads 6 there as an integral elongation.

The incandescent filament, consisting of tantalum carbide, of the lamp that is schematically shown in FIG. 1 and whose basic design corresponds largely to a low voltage halogen incandescent lamp available on the market is produced by carburizing a filament (12 turns) made from a tantalum wire (diameter 125 μm). When xenon is used as basic gas to which substances containing hydrogen, nitrogen, hydrocarbon and halogen (J, Br, Cl, F) containing substances have further been added during operation at 15 V the lamp has a power consumption of approximately 70 W, the color temperature characteristically being in the range 3200-3600 K.

The luminous element 7 is illustrated schematically with greater accuracy in FIG. 2. The pitch of the core wire 15, which has a diameter of 125 μm by way of example, is approximately 350 μm, there being 12 turns. The pitch factor of the wrapping wire with a diameter of 25 μm by way of example is approximately 1.2.

Core wire and wrapping together form a so-called wrapped filament. The materials correspond in this case to the embodiments discussed above.

Suitable metal carbides are, in particular, ones whose melting point lies above that of tungsten, or ones whose melting point lies at most 100° below that of tungsten.

1. An incandescent lamp having carbide-containing luminous elements and having supply leads that hold the luminous elements, a helically wound luminous element being introduced in a vacuum-tight fashion together with a filling in a bulb, the luminous element having a metal carbide whose melting point is preferably above that of tungsten, and the luminous element being constructed as a wrapped filament composed of a core wire and a wrapping surrounding the latter, characterized in that the core wire and the wrapping are made from different materials, at least one of the two components being fabricated from a high-melting metal carbide.

2. The incandescent lamp as claimed in claim 1, characterized in that the wrapping is a wrapping wire which is single-ply or multi-ply and which, in particular, consists of a number of wires of smaller diameter than that of the core wire.

3. The incandescent lamp as claimed in claim 1, characterized in that the high-melting carbide is tantalum carbide or an alloy of tantalum carbide with other metal carbides, metal nitrides and metal borides, and in that the second material after the lamp burn in is either another high-melting metal compound or a material selected from the group W, Re, Os, Ir, Ru that does not form carbide under the selected conditions.

4. The incandescent lamp as claimed in claim 3, characterized in that the other metal compound is another metal carbide from the group HfC, ZrC, NbC, VC, WC, TiC, SiC or alloys of these metal carbides with one another or with corresponding metal nitrides and/or metal borides.

5. The incandescent lamp as claimed in claim 1, characterized in that the envelope is fabricated from silica glass, hard glass or ceramic.

6. The incandescent lamp as claimed in claim 2, characterized in that the turn spacing of the wrapping wire is at most 1.5 times the diameter of the wrapping wire.

7. The incandescent lamp as claimed in claim 1, characterized in that the core wire is coated with carbon or is still affected by a carbon drawing lubricant from the wire drawing.

8. The incandescent lamp as claimed in claim 1, characterized in that the core wire itself is wrapped with a carbon fiber or a bundle of carbon fibers.

9. The incandescent lamp as claimed in claim 7, characterized in that the carbon coated core wire itself is wrapped again with a wire made from metal carbide or an alloy made from metal carbides selected from the group TaC, HfC, ZrC, NbC, VC, WC, TiC or alloys of these metal carbides with metal nitrides or metal borides.

10. The incandescent lamp as claimed in claim 8, characterized in that the fibers or the bundle themselves/itself are wrapped again by a wire made from metal carbide or an alloy made from metal carbides selected from the group TaC, HfC, ZrC, NbC, VC, WC, TiC or alloys of these metal carbides with metal nitrides or metal borides.

11. The incandescent lamp as claimed in claim 1, characterized in that the core wire consists of a material, in particular rhenium, ruthenium, osmium or iridium, which does not form carbides or forms carbides only to a small extent, while the wrapping wire consists of a metal carbide or an alloy of metal carbides selected from the group TaC, HfC, ZrC, NbC, VC, WC, TiC and, if appropriate, further of metal borides and metal nitrides.

12. The incandescent lamp as claimed in claim 2, characterized in that the wrapping wire is wound around the core wire in a multi-ply fashion.

13. The incandescent lamp as claimed in claim 11, characterized in that at least two different wrapping wires made from various metals or metal alloys, in particular metal carbides, are wound around the core wire.

14. The incandescent lamp as claimed in claim 1, characterized in that the core wire consists of tungsten and the wrapping is a wire that consists of tantalum carbide, in particular produced by specific carburization of tantalum alone, or of other metal carbides or their alloys (Hf, Zr, Nb, V, W, Ti), it also being possible, if appropriate, for the alloys further to contain metal nitrides or metal borides.

15. The incandescent lamp as claimed in claim 3, characterized in that the core wire consists of tungsten and the wrapping has at least two plies, the first ply being a wrapping wire that is selected from a material from the group of rhenium, osmium, iridium that acts as a carbon diffusion barrier, and a second and, if appropriate, further ply is a wrapping wire made from a metal carbide, preferably tantalum carbide, or a tantalum carbide alloy with other metal carbides, nitrides or borides.

16. The incandescent lamp as claimed in claim 1, characterized in that the carbon wire is a tungsten wire that is coated with a metal selected from the group of rhenium, osmium, iridium, there being fitted on this ply a wrapping wire fabricated from a metal carbide or from an alloy of metal carbides, nitrides and/or borides selected from the group of metals Ta, Hf, Zr, Nb, V, W, Ti.

17. The incandescent lamp as claimed in claim 1, characterized in that the core wire is a tungsten wire, the wrapping consisting of three plies, the first ply being a wrapping wire made from a material selected from the group of rhenium, osmium, iridium that acts as a carbon diffusion barrier, and the second ply being a fiber or layer that consists of a material that is selected from the group of carbon fiber or a carbon fiber layer, and the third ply being a wrapping wire made from metal carbide or a metal carbide alloy selected from the group of tantalum carbide, tantalum carbide alloy, ZrC, HfC, NbC, VC, WC, TiC.

18. The incandescent lamp as claimed in claim 1, characterized in that the core wire consists of a material such as, in particular, rhenium, osmium or iridium, that does not form, or scarcely forms, carbides, the core wire firstly being wrapped as second ply with a carbon fiber or being coated with carbon, and use being made as third ply of a wrapping wire made from a metal carbide or an alloy of the metal carbide with other metal carbides, nitrides or borides.

19. A method for producing an incandescent lamp as claimed in claim 1, characterized in that the high melting metals or metal alloys are firstly present in the uncarburized state in the finished lamp, and in that said metals or metal alloys are not carburized until the lamp is burnt in owing to reaction with a carbon containing fill gas, or to the use of the carbon from a carbon fiber or a carbon layer.
